(19) United States
(12) Patent Application Publication
(10) Pub. No.: US 2024/0064782 A1
(43) Pub. Date: Feb. 22, 2024

(54) METHOD AND APPARATUS FOR RESOURCE ALIGNMENT ON SIDELINK

(71) Applicant: Lenovo (Beijing) Limited, Beijing (CN)

(72) Inventors: Xin Guo, Beijing (CN); Xiaodong Yu, Beijing (CN); Haipeng Lei, Beijing (CN); Zhennian Sun, Beijing (CN)

(73) Assignee: Lenovo (Beijing) Limited, Beijing (CN)

(21) Appl. No.: 18/270,338

(22) PCT Filed: Dec. 30, 2020
(86) PCT No.: PCT/CN2020/141766

§ 371 Date: Jun. 29, 2023

(51) Int. Cl. H04W 72/40; H04W 72/02

(52) U.S. Cl. CPC H04W 72/40; H04W 72/02

(57) ABSTRACT

Embodiments of the present application relate to a method and an apparatus for resource alignment on sidelink (SL). According to an embodiment of the present application, a method can include: receiving resource partition information associated with at least one resource partition of a resource pool; selecting at least one resource pattern from a set of resource patterns associated with one resource partition of the at least one resource partition according to the received resource partition information; and transmitting an indication to indicate the selected at least one resource pattern. Embodiments of the present application can save power for UEs which perform SL communication in a power saving mode as well as decrease resource collision between different SL communications.

### TECHNICAL FIELD

Embodiments of the present application generally relate to wireless communication technology, especially to a method and an apparatus for resource alignment on sidelink (SL).

### BACKGROUND

Vehicle to everything (V2X) has been introduced into 5G wireless communication technology. In terms of a channel structure of V2X communication, a direct link between two user equipment (UEs) is called a sidelink. Sidelink is a long-term evolution (LTE) feature introduced in 3GPP Rel-12, and enables a direct communication between UEs in proximity, and data does not need to go through a base station (BS) or a core network.

In 3GPP Rel-16, NR sidelink is designed based on an assumption of “always-on” when UE operates on a sidelink, for example, only focusing on UEs installed in vehicles with sufficient battery capacity. Solutions for power saving in 3GPP Rel-17 are required for vulnerable road users (VRUs) in V2X use cases and for UEs in public safety and commercial use cases where power consumption in the UEs needs to be minimized. However, details regarding such solutions have not been discussed in 3GPP 5G NR technology yet.

Therefore, the industry desires an improved technology for resource alignment on NR sidelink so as to save power for UEs which preforms SL communication in a power saving mode.

### SUMMARY

Some embodiments of the present application provide a technical solution for resource alignment on NR sidelink.

According to some embodiments of the present application, a method performed by a first UE may include: receiving resource partition information associated with at least one resource partition of a resource pool; selecting at least one resource pattern from a set of resource patterns associated with one resource partition of the at least one resource partition according to the received resource partition information; and transmitting an indication to indicate the selected at least one resource pattern.

In some embodiments, the method may further include: determining the one resource partition from the at least one resource partition based on one of: an indication from a network; an indication from another UE; zone information; and pre-configuration.

In some embodiments, the resource partition information is received via at least one of: a system information block (SIB); a radio resource control (RRC) signaling; a medium access control (MAC) control element (CE); downlink control information (DCI); sidelink control information (SCI); and pre-configuration.

In some embodiments, the resource pool with a resource partition used for the resource pool is associated with at least one zone.

In some embodiments, the resource partition information includes at least one resource partition, and each of the at least one resource partition includes at least one of: a partition index associated with a corresponding resource partition; a partition default value indicating whether the corresponding resource partition is default or not; a maximum number of resource patterns within the corresponding resource partition; and information for each resource pattern in the corresponding resource partition.

In an embodiment, the information for each resource pattern includes at least one of: a pattern index associated with a corresponding resource pattern; a pattern length associated with the corresponding resource pattern; a pattern periodicity associated with the corresponding resource pattern; and a maximum number of elements of the corresponding resource pattern.

In an embodiment, a length of the pattern index is larger than or equal to max_{k∈[1 . . . K]}{┌log₂ N_{PATT}(PARₖ)┐}, wherein K is the number of resource partitions of a resource pool, and N_{PATT}(PARₖ) is the number of resource patterns within a resource partition PARₖ.

In some embodiments, the first UE determines a lower layer to transmit and/or receive based on a partial sensing using the resource pool and the resource partition information is included a resourceSelectionConfigP2X information element (IE), and the method further may further include: configuring the lower layer to transmit and/or receive based on the partial sensing using the resource pool with resource partition information.

In some embodiments, the first UE determines a lower layer to transmit in a power saving mode using the resource pool and the resource partition information is included a resourceSelectionConfigV2X IE, and the method may further include: configuring the lower layer to transmit using the resource pool based on the resource partition information.

In some embodiments, the method may further include: performing sensing in a sensing duration to identify one or more resource patterns used by at least one second UE; and in the case that none of resource pattern used by the at least one second UE is identified, selecting the at least one resource pattern within the one resource partition of the resource pool.

In an embodiment, the sensing duration is larger than or equal to the maximum pattern periodicity of the set of resource patterns within the one resource partition.

In another embodiment, selecting the at least one resource pattern from the set of resource patterns may include at least one of: selecting at least one default resource pattern from the set of resource patterns as the at least one resource pattern; randomly selecting the at least one resource pattern from the set of resource patterns; and selecting the at least one resource pattern according to sensing results of the sensing.

In another embodiment, the method may further include: selecting one or more resources within the at least one resource pattern; and transmitting the indication on the selected one or more resources.

In another embodiment, the indication is transmitted once, multiple times, or periodically on the selected one or more resources.

In some embodiments, the first UE is in communication with a second UE over sidelink using a first set of resources, and the selecting is performed in response to one of the followings: receiving a request for resource pattern selection in the first set of resources from the second UE; the first UE switching from a non-power saving mode to a power saving mode; and current resource pattern(s) being used by the first UE cannot satisfy transmission requirements.

In an embodiment, the at least one resource pattern is selected based on at least one of: transmission requirements between the first UE and a second UE; sensing results of a sensing performed in a sensing duration, wherein the sensing duration is larger than or equal to the maximum pattern periodicity of the set of resource pattern within the one resource partition.

In another embodiment, the indication is transmitted in a second set of resources within the first set of resources.

In yet another embodiment, the method may further include: receiving feedback information on the indication in a third set of resources within the first set of resources, wherein the third set of resources is associated the second set of resources.

In yet another embodiment, the method may further include: in the case that the feedback information indicates an acknowledgment (ACK) for the indication, switching from the first set of resources to the at least one resource pattern for communicating with the second UE over the sidelink.

In yet another embodiment, the method may further include: in the case that the feedback information indicates a non-acknowledgment (NACK) for the indication, remaining the first set of resources unchanged for communicating with the second UE over the sidelink.

In some embodiments, the indication is transmitted via a MAC CE, or via a PC5 RRC signalling, or via SCI.

According to some other embodiments of the present application, a method performed by a second UE may include: receiving resource partition information associated with at least one resource partition of a resource pool; and receiving an indication to indicate at least one resource pattern of a set of resource patterns associated with one resource partition of the at least one resource partition from a first UE.

In some embodiments, the method may further include: determining the one resource partition from the at least one resource partition based on one of: an indication from a network; an indication from another UE; zone information; and pre-configuration.

In some embodiments, the resource partition information is received via at least one of: a SIB; a RRC signaling; a MAC CE; DCI; SCI; and pre-configuration.

In some embodiments, the resource pool with a resource partition used for the resource pool is associated with at least one zone.

In some embodiments, the resource partition information includes at least one resource partition, and each of the at least one resource partition includes at least one of: a partition index associated with a corresponding resource partition; a partition default value indicating whether the corresponding resource partition is default or not; a maximum number of resource patterns within the corresponding resource partition; and information for each resource pattern in the corresponding resource partition.

In an embodiment, the information for each resource pattern includes at least one of: a pattern index associated with a corresponding resource pattern; a pattern length associated with the corresponding resource pattern; a pattern periodicity associated with the corresponding resource pattern; and a maximum number of elements of the corresponding resource pattern.

In an embodiment, a length of the pattern index is larger than or equal to max_{k∈[1 . . . K]}{┌log₂ N_{PATT}(PARₖ)┐}, wherein K is the number of resource partitions of a resource pool, and N_{PATT}(PARₖ) is the number of resource patterns within a resource partition PARₖ.

In some embodiments, the second UE determines a lower layer to transmit and/or receive based on a partial sensing using the resource pool and the resource partition information is included a resourceSelectionConfigP2X information element (IE), and the method further may further include: configuring the lower layer to transmit and/or receive based on the partial sensing using the resource pool with resource partition information.

In some embodiments, the second UE determines a lower layer to transmit in a power saving mode using the resource pool and the resource partition information is included a resourceSelectionConfigV2X IE, and the method may further include: configuring the lower layer to transmit using the resource pool based on the resource partition information.

In some embodiments, the indication is transmitted once, multiple times, or periodically on the selected one or more resources.

In some embodiments, the second UE is in communication with the first UE over sidelink using a first set of resources, and the method may further include: transmitting a request for resource pattern selection in the first set of resources to the first UE; and transmitting a request for resource pattern selection in the first set of resources to the first UE.

In an embodiment, the indication is received in a second set of resources within the first set of resources.

In another embodiment, the method may further include: transmitting feedback information on the indication in a third set of resources within the first set of resources, wherein the third set of resources is associated the second set of resources.

In yet another embodiment, the method may further include: in the case that the feedback information indicates an ACK for the indication, switching from the first set of resources to the at least one resource pattern for communicating with the second UE over the sidelink.

In yet another embodiment, the method may further include: in the case that the feedback information indicates a NACK for the indication, remaining the first set of resources unchanged for communicating with the second UE over the sidelink.

In some embodiments, the indication is received via a MAC CE, or via a PC5 RRC signalling, or via SCI.

According to some other embodiments of the present application, a method may include: transmitting resource partition information associated with at least one resource partition of a resource pool; and transmitting an indication indicating one resource partition of the at least one resource partition.

In some embodiments, the resource partition information is received via at least one of: a SIB; a RRC signaling; and a MAC CE.

In some embodiments, the resource pool with a resource partition used for the resource pool is associated with at least one zone.

In some embodiments, the resource partition information includes at least one resource partition, and each of the at least one resource partition includes at least one of: a partition index associated with a corresponding resource partition; a partition default value indicating whether the corresponding resource partition is default or not; a maximum number of resource patterns within the corresponding resource partition; and information for each resource pattern in the corresponding resource partition.

In an embodiment, the information for each resource pattern includes at least one of: a pattern index associated with a corresponding resource pattern; a pattern length associated with the corresponding resource pattern; a pattern periodicity associated with the corresponding resource pattern; and a maximum number of elements of the corresponding resource pattern.

In an embodiment, a length of the pattern index is larger than or equal to max_{k∈[1 . . . K]}{┌log₂ N_{PATT}(PARₖ)┐}, wherein K is the number of resource partitions of a resource pool, and N_{PATT}(PARₖ) is the number of resource patterns within a resource partition PARₖ.

Some embodiments of the present application also provide an apparatus, include: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

Embodiments of the present application provide a technical solution for resource alignment on sidelink. Accordingly, embodiments of the present application can save power for UEs which perform SL communication in a power saving mode as well as decrease resource collision between different SL communications.

### BRIEF DESCRIPTION OF THE DRAWINGS

In order to describe the manner in which advantages and features of the application can be obtained, a description of the application is rendered by reference to specific embodiments thereof, which are illustrated in the appended drawings.

These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary resource partition of a resource pool according to some embodiments of the present application.

FIG. 3 illustrates an exemplary resource pattern selection procedure according to some embodiments of the present application;

FIG. 4 illustrates an exemplary timing diagram of resource pattern selection according to some embodiments of the present application;

FIG. 5 illustrates another exemplary resource pattern selection procedure according to some other embodiments of the present application;

FIG. 6 illustrates another exemplary timing diagram of resource pattern selection according to some other embodiments of the present application;

FIG. 7 illustrates a flow chart of a method for resource alignment on sidelink according to some embodiments of the present application;

FIG. 8 illustrates a flow chart of a method for resource alignment on sidelink according to some other embodiments of the present application;

FIG. 9 illustrates a flow chart of a method for resource alignment on sidelink according to some other embodiments of the present application; and

FIG. 10 illustrates a simplified block diagram of an apparatus 1000 for resource alignment on sidelink according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G (NR), 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

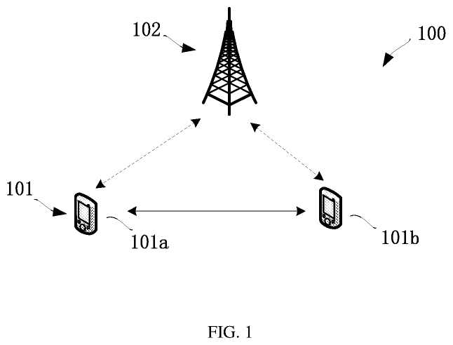

FIG. 1 is a schematic diagram illustrating an exemplary wireless communication system according to some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

In some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some other embodiments of the present application, the UE(s) 101 may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. In an embodiment of the present application, the UE(s) 101 may be a pedestrian UE (P-UE), a cyclist UE, a vulnerable road user (VRU), a vehicle UE (V-UE), or the like.

According to some embodiments of FIG. 1, UE 101a functions as Tx UE, and UE 101b functions as Rx UE. UE 101a may exchange V2X messages with UE 101b through a sidelink, for example, PC5 interface as defined in 3GPP TS 23.303. UE 101a may transmit information or data to other UE(s) within the V2X communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as Tx UE and transmits V2X messages, UE 101a functions as Rx UE and receives the V2X messages from UE 101b.

Both UE 101a and UE 101b in the embodiments of FIG. 1 may transmit information to BS 102 and receive control information from BS 102, for example, via LTE or NR Uu interface. The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL) and the UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

In 3GPP standard document TS 36.300, the design related to partial sensing for UE (e.g., P-UE) is as follows. Resource pool for transmission of UE (e.g., P-UE) may be overlapped with resources for V2X sidelink communication. For each transmission pool, a resource selection mechanism (i.e., a random selection procedure, or a partial sensing based selection mechanism), which is allowed to be used in this transmission pool, is also configured.

A partial sensing based selection mechanism may also be named as a partial sensing based resource selection mechanism, a partial sensing mechanism, a partial sensing procedure, or the like. If a UE (e.g., P-UE) is configured to use either a random selection mechanism or a partial sensing based selection mechanism for one transmission pool, it is up to implementations of the UE to select a specific resource selection mechanism.

If a UE (e.g., a P-UE) is configured to use a partial sensing based selection mechanism only, the UE shall use the partial sensing based selection mechanism in the pool. The UE shall not do a random selection mechanism in the pool, since only a partial sensing operation is allowed. If a BS does not provide a random selection pool, the UE that supports only a random selection mechanism cannot perform sidelink transmission. In exceptional pool, the UE uses a random selection mechanism. The UE can send sidelink UE information message to indicate that it requests resource pools for a pedestrian to everything (P2X) related sidelink communication transmission, as specified in 3GPP standard document TS 36.331.

According to 3GPP standard document TS 36.213, if UE (e.g., P-UE) is configured to use a partial sensing based selection (or reselection) mechanism, the UE will monitor the resource only in a subset of subframes. In addition, the UE should have sensed on a sensing window with all allowed resource reservation periodicities configured by a higher layer (e.g., MAC layer or a layer higher than the MAC layer) before using sensing result(s) for resource selection (or reselection) mechanism.

Resource selection based on the partial sensing may save power for VRUs because only a subset of resources needs to be monitored for resource selection. In Rel-17, in addition to supporting a transmission function for the VRU, the V2X is additionally supposed to support a reception function for VRU. Given this, configuring an identical subset of resource (which may be referred as communication window) for both the transmission and reception may provide a good compromise between energy consumption and collision probability of resource selection.

Under this circumstance, if the pattern of communication window is left for UE implementation, two problems will be caused as follows. One problem is the heavy resource collision caused due to no alignment among UEs. The other problem is the high signaling overhead for sharing information of the patterns among UEs. Therefore, to facilitate communication among UEs on a subset of resource, it is beneficial to specify detailed solutions regarding how to partition the resource pool and how to align the partition information among UEs.

Given the above, embodiments of the present application aim to provide solutions for resource alignment for NR sidelink. Accordingly, embodiments of the present application can save power for UEs which perform SL communication in a power saving mode as well as decrease resource collision between different SL communications. More details on embodiments of the present application will be illustrated in the following text in combination with the appended drawings.

According to some embodiments of the present application, a UE (e.g., UE 101a or UE 101b as shown in FIG. 1) may be configured with one or more resource pools. The UE may select one resource pool (e.g., a resource pool S) from the one or more resource pools for SL communication. For example, the UE may select one resource pool (e.g., resource pool S) as specified in 3GPP standard documents.

In some embodiments, the UE may be a UE configured to perform SL communication in a power saving mode. For example, the UE may be a VRU which is configured to transmit and/or receive P2X related SL communication. In another example, the UE may be a non-VRU which is configured to transmit P2X related SL communication.

In some embodiments, in order to align resource between UEs, a resource pool may be configured with at least one resource partition. Each resource partition may further have at least one resource pattern. The configuration information regarding the resource partition and resource pattern may be included in resource partition information. In these embodiments, for each resource pool, the UE may receive resource partition information associated with at least one resource partition of the corresponding resource pool.

For example, for the selected resource pool S, the UE may receive resource partition information associated with at least one resource partition of the resource pool S. The at least one resource partition for the resource pool S may be denoted as PARₖ, k∈[1 . . . K], K≥1, wherein K is an integer and K is the number of the resource partitions of the resource pool S. Accordingly, given the resource pool S, each resource partition may be indicated by its index k. At any point in the time domain and/or the space domain, only one resource partition is used for the resource pool by the UE.

In an embodiment, the resource partition information may be received via a SIB from the network (e.g., a BS 102 as shown in FIG. 1). In another embodiment, the resource partition information may be received via a RRC signaling from the network or another UE. In yet another embodiment, the resource partition information may be received via a MAC CE from the network or another UE. In yet another embodiment, the resource partition information may be received via DCI from the network. In yet another embodiment, the resource partition information may be received via SCI from another UE. In yet another embodiment, the resource partition information may be received via pre-configuration. For example, the resource partition information may be pre-configured in the UE or may be the default resource partition information.

In some embodiments, the resource pool S with a resource partition used for the resource pool S is associated with at least one zone as specified in 3GPP standard documents, which is indicated by zone information. In the case that the UE is located in a zone associated with the resource pool S, the UE may select the resource partition used for the resource pool S.

In some embodiments, the resource partition information may include at least one resource partition. In each resource partition, the resource pool may be divided into a disjoint set of resource patterns in the time domain. That is, each resource partition may be associated with (or include) a set of resource patterns. The set of resource patterns may include at least one resource pattern.

In an embodiment, each of the at least one resource partition may include at least one of: a partition index associated with a corresponding resource partition; a partition default value indicating whether the corresponding resource partition is default or not; a maximum number of resource patterns within the corresponding resource partition; and information for each resource pattern in the corresponding resource partition.

The information for each resource pattern may include at least one of: a pattern index associated with a corresponding resource pattern; a pattern length associated with the corresponding resource pattern; a pattern periodicity associated with the corresponding resource pattern; and a maximum number of elements of the corresponding resource pattern.

For example, for each resource partition k, the set of resource patterns associated with the corresponding resource partition k may be denoted as PATTₗ, l∈[1 . . . L], L≥1, wherein L is an integer and L is the number of the resource patterns associated with the corresponding resource partition k. Within each resource partition, any two different patterns do no overlap with each other in the time domain, i.e., PATTᵢ ∩PATTⱼ=Ø, i, j∈[1 . . . L], i≠j. The union of all resource patterns within each resource partition constructs a subset of the resource pool S, i.e., U_{l∈[1 . . . L]}PATTₗ ⊆S.

Given the resource partition k, each resource pattern PATTₗ within the resource partition k may be indicated by its index l. The length of pattern index (e.g., denoted by LengthPatternIndex) may be defined as the number of bits required to individually represent each resource pattern within any resource partition for the resource pool. For example, assuming that the number of resource patterns within a resource partition PARₖ is denoted by N_{PATT}(PARₖ), then the length of pattern index for the resource pool S should satisfy LengthPatternIndex≥max_{k∈[1 . . . K]}{┌log₂ N_{PATT}(PARₖ)┐}, wherein K is the number of resource partitions of the resource pool S.

In some embodiments, the resource partition information may be denoted by resourcePartitionInfo, which is an information element (IE) used to describe every partition within a resource pool S and every pattern within each partition. The resourcePartitionInfo may include at least one resourcePartition IE. Each resourcePartition IE may include parameters associated with a corresponding resource partition. An example of a resourcePartition IE for a resource partition k of a resource pool S may be defined by parameters listed in Table 1.

TABLE 1
parameters included in a resource partition

| Parameter | | Description |
|---|---|---|
| partitionIndex | | A parameter to indicate a resource |
| | | partition among at least one |
| | | resource partition for the |
| | | resource pool. |
| partitionDefault | | A parameter to indicate if the |
| | | resource partition is default or |
| | | not. The parameter can be |
| | | Boolean type. |
| partitionMaxNum | | A parameter to indicate the |
| | | maximum number of resource |
| | | patterns within the resource |
| | | partition. |
| Information | patternIndex | A parameter to indicate a |
| for each | | resource pattern among a set of |
| resource | | patterns for a resource partition. |
| pattern | patternOffset | A parameter to indicate an |
| | | offset of the resource pattern. |
| | | The parameter is measured in |
| | | number of slots. The reference |
| | | point for the offset is with |
| | | respect to the first slot (e.g., |
| | | slot #0) of the first radio frame |
| | | (e.g., RF #0). |
| | patternLength | A parameter to indicate a length |
| | | of an element of a resource |
| | | pattern in time domain. The |
| | | parameter is measured in |
| | | number of slots. |
| | patternPeriodicity | A parameter to indicate the |
| | | interval between starting points |
| | | (or end points, or midpoints) of |
| | | two adjacent elements of a |
| | | resource pattern in time domain. |
| | | The parameter is measured in |
| | | number of slots. |
| | patternMaxNum | A parameter to indicate the |
| | | maximum number of elements |
| | | of the resource pattern within |
| | | the resource pool of S. The |
| | | parameter is optional. The |
| | | default value of this parameter |
| | | can be calculated as [Lengthₛ/ |
| | | patternPeriodicity] , wherein |
| | | Lengthₛ represents the number |
| | | of slots of the resource pool S. |

Referring to table 1, the resourcePartition IE for a resource partition k may include a parameter partitionIndex to indicate the resource partition k among at least one partition for the resource pool, a parameter partitionDefault to indicate if the resource partition is default or not, a parameter partitionMaxNum to indicate the maximum number of resource patterns within the resource partition, and information for each resource pattern of the at least one resource pattern associated with the resource pool. The information for each resource pattern may include a parameter patternIndex to indicate a corresponding resource pattern among the set of resource patterns for the resources partition k, a parameter patternOffset to indicate an offset of the corresponding resource pattern, a parameter patternLength indicate the length of an element of the corresponding resource pattern in time domain, a parameter patternPeriodicity indicate the interval between starting points (or end points) of two adjacent elements of the corresponding resource pattern in time domain, and an optional parameter patternMaxNum to indicate the maximum number of elements of the resource pattern within the resource pool. Although table 1 shows all the parameters included in a resource partition, the resource partition may include a portion of these parameters in some other embodiments.

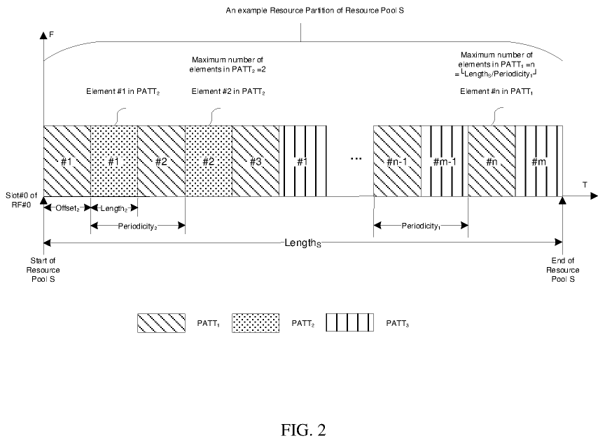

FIG. 2 illustrates an exemplary resource partition of a resource pool according to some embodiments of the present application.

Referring to FIG. 2, the resource pool S may start from a start slot (e.g., the first slot (e.g., slot #0) of the first radio frame (e.g., RF #0)) and have a length Lengths in terms of a number of slots.

The resource pool S may have at least one resource partition. FIG. 2 shows one resource partition of the at least one resource partition. The resource partition shown in FIG. 2 may include three resource patterns (e.g., PATT₁, PATT₂, and PATT₃). Any two different patterns do no overlap with each other. Each resource pattern may have one or more elements. The resource element may include a set of consecutive resources in the time domain and/or the frequency domain. Each resource pattern may be configured with a pattern offset, a pattern length of an element in the resource pattern, a pattern periodicity indicating an interval between starting points of two adjacent elements in the resource pattern in time domain, and a maximum number of elements (which is optionally) in the resource pattern.

Taking PATT₂ as an example, the offset of the PATT₂ may be offset₂ as shown in FIG. 2, the pattern length of PATT₂ may be Length₂ as shown in FIG. 2, the pattern periodicity of PATT₂ may be Periodicity₂ between element #1 and element #2 of PATT₂ as shown in FIG. 2, and maximum number of elements of PATT₂ may be 2 as shown in FIG. 2. Compared with PATT₂, the maximum number of elements of PATT₁ may be not configured for PATT₁ (i.e., the parameters for the PATT₁ does not include the maximum number of elements of PATT₁). Given this, the maximum number of elements of PATT₁ may be a default value, which can be calculated as [Length_{S}/Periodicity₁], wherein Length_{S} represents the number of slots of the resource pool S, and Periodicity₁ represents the pattern periodicity of PATT₁.

According to some embodiments of the present application, after receiving the resource partition information, the UE may perform transmission and/or reception based on the resource partition information.

In some embodiments, the UE may be configured to transmit and/or receive P2X related sidelink communication. If the UE determines a lower layer (e.g., a layer lower than a RRC layer) to transmit and/or receive based on partial sensing using the selected resource pool and the resource partition information (e.g., resourcePartitionInfo IE) is included in resourceSelectionConfigP2X of the selected pool as specified in 3GPP standard documents, the UE may configure the lower layer to transmit and/or receive (e.g., the sidelink control information and/or the corresponding data) based on the partial sensing using the selected resource pool coupled with resource partition information.

In some other embodiments, the UE may be configured to transmit V2X sidelink communication. If the UE determines a lower layer to transmit in a power saving mode using the selected resource pool and the resource partition information (e.g., resourcePartitionInfo IE) is included in resourceSelectionConfigV2X of the selected pool as specified in 3GPP standard documents, the UE may configure the lower layer to transmit (e.g., the sidelink control information and/or the corresponding data) using the selected resource pool coupled with the resource partition information.

As stated above, the resource partition information may include at least one partition of a resource pool. However, in order to align resource and reduce collision between UEs, at any point in the time domain and/or the space domain, only one resource partition is used for the resource pool by the UE. There are several methods for determining which resource partition is used by the UE.

In an embodiment, the UE may determine the one resource partition from the at least one resource partition based on an indication from a network (e.g., BS 102 as shown in FIG. 1). In another embodiment, the UE may determine the one resource partition from the at least one resource partition based on an indication from another UE. In yet another embodiment, the UE may determine the one resource partition from the at least one resource partition based on zone information. For example, the resource pool with a resource partition used for the resource pool may be associated with at least one zone as specified in 3GPP standard documents, which is indicated by zone information. In the case that the UE is located in a zone associated with the resource pool S, the UE may select the resource partition used for the resource pool S. In yet another embodiment, the UE may determine the one resource partition from the at least one resource partition based on pre-configuration. For example, using which resource partition may be pre-configured in the UE or UE may use a default resource partition.

The resource partition information may be used for a UE to start communications over SL. For example, after receiving the resource partition information and determining one resource partition, in the case that the UE plans to communication over SL, the UE may first select at least one resource pattern from a set of resource pattern of the one resource partition.

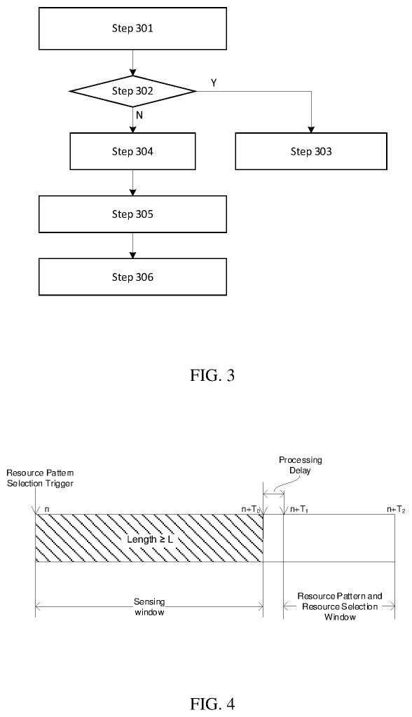

FIG. 3 illustrates an exemplary resource pattern selection procedure according to some embodiments of the present application. The resource pattern selection procedure as shown in FIG. 3 may be performed by a first UE (e.g., UE 101a) which plans to communicate with other UEs over SL. In an embodiment, the first UE may be a power-sensitive UE.

Before performing the resource pattern selection procedure in FIG. 3, the first UE may receive the resource partition information and determine one resource partition based on the above methods.

Referring to FIG. 3, at step 301, the first UE may perform sensing in a sensing duration to identify one or more resource patterns used by at least one second UE. The sensing duration is larger than or equal to the maximum pattern periodicity of the set of resource patterns within the one resource partition. For example, assuming that the one resource partition includes three resource patterns (e.g., PATT₁, PATT₂, and PATT₃) and the pattern periodicities of the three resource patterns may be Periodicity₁ slots, Periodicity₂ slots, and Periodicity₃ slots, respectively. If Periodicity₁ is the largest value, then the sensing duration should be larger than or equal to Periodicity₁ slots.

At step 302, the first UE may determine whether the one or more resource patterns used by the at least one second UE is identified in the resource partition.

At step 303, in the case that that at least one resource pattern associated with a second UE is identified in the one resource partition, the first UE may communicate on the identified at least one resource pattern with the second UE.

At step 304, in the case that none of resource pattern used by the at least one second UE is identified, the first UE may select at least one resource pattern within the one resource partition of the resource pool.

In an embodiment, the first UE may select at least one default resource pattern from the set of resource patterns as the at least one resource pattern. In another embodiment, the first UE may randomly select the at least one resource pattern from the set of resource patterns. In yet another embodiment, the first UE may select the at least one resource pattern according to sensing results of the sensing.

After selecting the at least one resource pattern, at step 305, the first UE may select one or more resources within the at least one resource pattern. Then, at step 306, the first UE may transmit an indication indicating the selected at least one resource pattern on the selected one or more resources.

In some embodiments, the indication may be transmitted only once, multiple times, or even periodically on the selected one or more resources. In an embodiment, how to transmit the indication can be determined according to the requirement of future transmission. In another embodiment, for the periodic transmission of the indication, the periodicity can be determined according to the selected at least one resource pattern.

In some embodiments, the indication may be an explicit indication or implicit indication. For example, when only one resource pattern is selected, the implicit indication may be used. In an embodiment, the indication may be multiplexed with data transmission.

In an embodiment, the indication may be transmitted via a MAC CE. In another embodiment, the indication may be transmitted via a PC5 RRC signaling. In yet another embodiment the indication may be transmitted via SCI.

FIG. 4 illustrates an exemplary timing diagram of resource pattern selection according to some embodiments of the present application.

Referring to FIG. 4, it is assumed that the resource pattern selection for the first UE may be trigger at time n, which means that the first UE may start the sensing at time n. Then the first UE may perform sensing within the duration of [n, n+T₀](e.g., the sensing window in FIG. 4) for the subsequent resource pattern selection, wherein T₀≥L and L is the maximum pattern periodicity of the set of resource patterns within the one resource partition.

After a processing delay T₁−T₀, at time n+T₁, the first UE may begin to perform resource pattern selection and resource selection from at least one resource pattern within a window (e.g., resource pattern and resource selection window in FIG. 4). The window may have a duration of [n+T₁, n+T₂].

The resource partition information may also be used for a pair of UEs which are in communication over SL with each other.

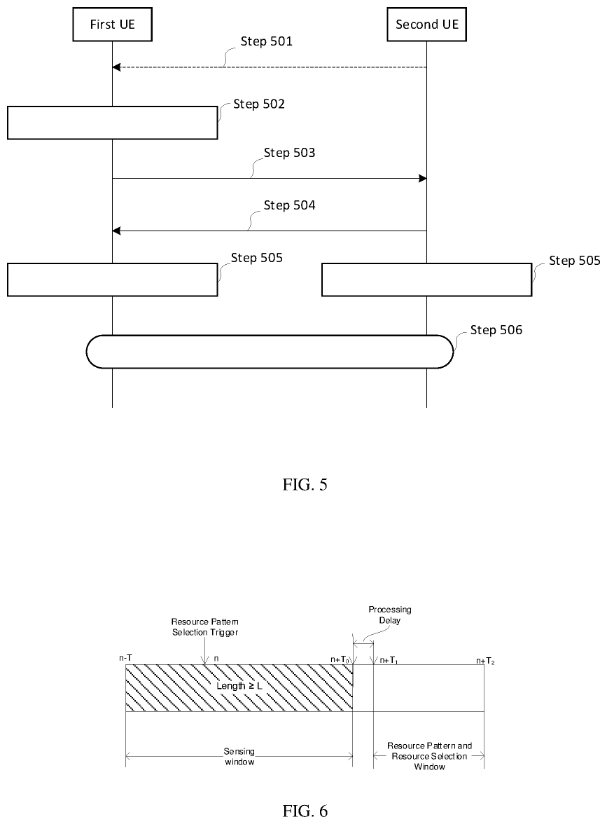

FIG. 5 illustrates an exemplary resource pattern selection procedure according to some embodiments of the present application. The resource pattern selection procedure as shown in FIG. 5 may be performed by a first UE (e.g., UE 101a) and a second UE (e.g., UE 101b) which are in communication with each other.

Before performing the resource pattern selection procedure in FIG. 5, the first UE and the second UE may receive the resource partition information and determine one resource partition based on the indication as stated above.

Referring to FIG. 5, at step 501, the second UE may transmit a request for resource pattern selection to the first UE. The request may be transmitted in a first set of resources, wherein the first UE are currently in communication with the second UE over SL using the first set of resources.

After receiving the request, at step 502, the first UE may select at least one resource pattern from a set of resource patterns associated with the one resource partition determined before.

Step 501 is an optional step. That is, in some other embodiments, the first UE may select the at least one resource pattern in response to other conditions. That is, the selecting may be triggered based on other conditions. For example, the first UE may select the at least one resource pattern in response to the first UE switching from a non-power saving mode to a power saving mode. In another example, the first UE may select the at least one resource pattern in response to current resource pattern(s) being used by the first UE cannot satisfy transmission requirements.

In some embodiments, the first UE may select the at least one resource pattern based on at least one of: transmission requirements between the first UE and a second UE; and sensing results of a sensing performed in a sensing duration. The sensing duration is larger than or equal to the maximum pattern periodicity of the set of resource pattern within the one resource partition. In some embodiments, the detailed method on how to select the at least resource pattern may be left to UE implementation.

After selecting the at least one resource pattern, at step 503, the first UE may transmit an indication indicating the selected at least one resource pattern to the second UE. The indication may be transmitted in a second set of resources within the first set of resources.

In an embodiment, the indication may be transmitted via a MAC CE. In another embodiment, the indication may be transmitted via a PC5 RRC signaling. In yet another embodiment the indication may be transmitted via SCI. In some embodiments, how to select the second set of resources can reuse resource selection methods specified in 3GPP standard documents.

After receiving the indication indicating at least one resource pattern from the first UE, at step 504, the second UE may transmit feedback information on the indication in a third set of resources within the first set of resources. The third set of resources may be associated with the second set of resources. The association between the second set of resources and the third set of resources may be defined in the first set of resources or may be indicated by the indication.

In some embodiments, the feedback information may be a hybrid automatic repeat request (HARQ) feedback for sidelink, as specified in 3GPP standard documents.

In the case that the feedback information indicates an ACK for the indication, at step 505, the first UE and the second UE may switch from the first set of resources to the at least one resource pattern for communicating with each other over the sidelink. Then at step 506, the first UE and the second UE may communicate on resources within the at least one resource pattern until the at least one resource pattern is changed.

In the case that the feedback information indicates a NACK for the indication, the first UE and the second UE may remain the first set of resources unchanged and will communicate on the first set of resources until the resource range is changed.

FIG. 6 illustrates an exemplary timing diagram of resource pattern selection according to some embodiments of the present application. The resource pattern selection as shown in FIG. 6 may be performed during step 502 in FIG. 5.

Referring to FIG. 6, it is assumed that the resource pattern selection for the first UE may be triggered at time n. Since the first UE and the second UE are in communication with each other before time n, time n may not be the start point of the first UE to perform the sensing. That is, at a time duration n−T, the first UE may start to sense. When the resource pattern selection is triggered, the first UE may keep sensing until a total sensing time (i.e., T₀+T) of a sensing window (i.e., [n−T, n+T₀]) is reached. The length of the sensing window is larger than or equal to L, wherein L is the maximum pattern periodicity of the set of resource patterns within the one resource partition.

After a processing delay T₁−T₀, at time n+T₁, the first UE may begin to perform resource pattern selection and resource selection from at least one resource pattern within a window (e.g., resource pattern and resource selection window in FIG. 6). The window may have a duration the duration of [n+T₁, n+T₂].

In the example of FIG. 6, the time n can be at any time point of the sensing window. That is, n∈[n−T, n+T₀] and T₀+T≥L. However, in other embodiments, before time n, the first UE may not perform any sensing. Then the first UE may start to perform sensing at time n, and the timing of the resource pattern selection may be shown in FIG. 4.

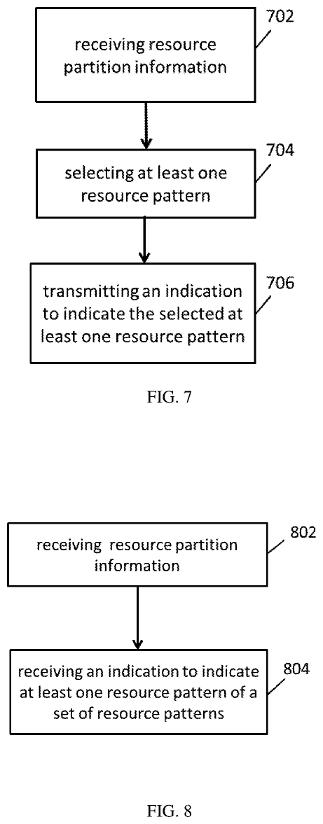

FIG. 7 is a flow chart illustrating a method for resource alignment on sidelink according to some embodiments of the present application. The method may be performed by a first UE (e.g., 101a) in FIGS. 3 and 5.

As shown in FIG. 7, in step 702, the first UE may receive resource partition information associated with at least one resource partition of a resource pool. The parameters included in the resource partition information may be the same as those in the embodiments stated above.

In some embodiments, the first UE may determine a lower layer to transmit and/or receive based on a partial sensing using the resource pool and the resource partition information is included a resourceSelectionConfigP2X information element (IE), then the first UE may configure the lower layer to transmit and/or receive based on the partial sensing using the resource pool with resource partition information.

In some embodiments, the first UE may determine a lower layer to transmit in a power saving mode using the resource pool and the resource partition information is included a resourceSelectionConfigV2X IE, and the first UE may configure the lower layer to transmit using the resource pool based on the resource partition information.

In some embodiments, the first UE may further determine one resource partition from the at least one resource partition based on one of: an indication from a network; an indication from another UE; zone information; and pre-configuration.

In an embodiment, the first UE may be a UE which plans to communicate with other UEs over SL. Then, the first UE may perform sensing in a sensing duration to identify one or more resource patterns used by at least one second UE.

In the case that none of resource pattern used by the at least one second UE is identified, at step 704, the first UE may select at least one resource pattern from a set of resource patterns associated with the one resource partition of the at least one resource partition according to the received resource partition information.

After that, the first UE may select one or more resources within the at least one resource pattern. Then, in step 706, the first UE may transmit the indication on the selected one or more resources. The indication may be transmitted once, multiple times, or periodically on the selected one or more resources.

In another embodiment, the first UE may be a UE which is in communication with a second UE over sidelink using a first set of resources.

Then, at step 704, the first UE may select at least one resource pattern from a set of resource patterns associated with the one resource partition in response to one of the followings: receiving a request for resource pattern selection in the first set of resources from the second UE; the first UE switching from a non-power saving mode to a power saving mode; and current resource pattern(s) being used by the first UE and the second UE cannot satisfy transmission requirements.

After selecting the at least one resource pattern, in step 706 the first UE may transmit an indication indicating the at least one resource pattern in a second set of resources within the first set of resources to the second UE.

After that, the first UE may receive feedback information on the indication in a third set of resources within the first set of resources, wherein the third set of resources is associated the second set of resources.

In the case that the feedback information indicates an ACK for the indication, the first UE may switch from the first set of resources to the at least one resource pattern for communicating with the second UE over the sidelink. In the case that the feedback information indicates a NACK for the indication, the first UE may remain the first set of resources unchanged for communicating with the second UE over the sidelink.

FIG. 8 is a flow chart illustrating a method for resource alignment on sidelink according to some other embodiments of the present application. The method may be performed by a second UE (e.g., 101b) in FIGS. 3 and 5.

As shown in FIG. 8, in step 802, the second UE may receive resource partition information associated with at least one resource partition of a resource pool from a BS. The parameters included in the resource partition information may be the same as those in the embodiments stated above.

In some embodiments, the second UE may determine a lower layer to transmit and/or receive based on a partial sensing using the resource pool and the resource partition information is included a resourceSelectionConfigP2X information element (IE), then the second UE may configure the lower layer to transmit and/or receive based on the partial sensing using the resource pool with resource partition information.

In some embodiments, the second UE may determine a lower layer to transmit in a power saving mode using the resource pool and the resource partition information is included a resourceSelectionConfigV2X IE, and the second UE may configure the lower layer to transmit using the resource pool based on the resource partition information.

In some embodiments, the second UE may further determine one resource partition from the at least one resource partition based on one of: an indication from a network; an indication from another UE; zone information; and pre-configuration.

In an embodiment, the second UE may be a UE for which a first UE plans to communicate over SL. Then, at step 804, the second UE may receive an indication to indicate at least one resource pattern of a set of resource patterns associated with the one resource partition of the at least one resource partition from the first UE. The indication may be received once, multiple times, or periodically on one or more resources of the at least one resource pattern

In another embodiment, the second UE may be a UE which is in communication with a first UE over sidelink using a first set of resources.

In this case, the second UE may transmit a request for resource pattern selection in the first set of resources to the first UE. This step is an optional step. In some embodiments, the second UE may not transmit a request for resource pattern selection in the first set of resources to the first UE.

At step 804, the second UE may receive an indication to indicate at least one resource pattern of a set of resource patterns associated with the one resource partition of the at least one resource partition from the first UE. The indication may be received in a second set of resources within the first set of resources. This indication may be in response to the request for resource pattern selection or may be in response to other conditions.

After receiving the indication, the second UE may transmit feedback information on the indication in a third set of resources within the first set of resources, wherein the third set of resources is associated the second set of resources.

In the case that the feedback information indicates an ACK for the indication, the second UE may switch from the first set of resources to the at least one resource pattern for communicating with the first UE over the sidelink. In the case that the feedback information indicates a NACK for the indication, the second UE may remain the first set of resources unchanged for communicating with the first UE over the sidelink.

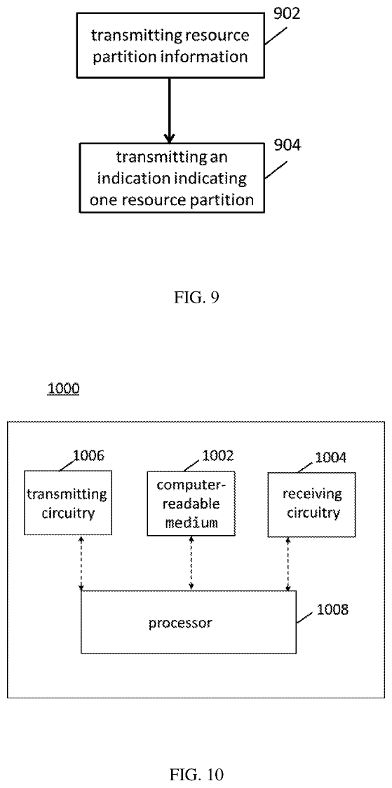

FIG. 9 is a flow chart illustrating a method for resource alignment on sidelink according to some other embodiments of the present application. The method may be performed by a BS (e.g., BS 102) in FIGS. 3 and 5.

As shown in FIG. 9, at step 902, the BS may transmit resource partition information associated with at least one resource partition of a resource pool to one or more UEs which plans to communicate with other UEs over SL and/or which are in communication with other UEs over SL (e.g., the first UE and the second UE in FIGS. 3 and 5). The parameters included in the resource partition information may be the same as those in the embodiments stated above.

At step 904, the BS may transmit an indication indicating one resource partition of the at least one resource partition such that the UEs which receive the resource partition information may use the parameters associated with the one resource partition to perform communications over SL. Although in the example of FIG. 9, step 904 may occur after step 902, in some other embodiments, step 904 and step 902 may occur simultaneously.

FIG. 10 illustrates a simplified block diagram of an apparatus 1000 for resource alignment on sidelink according to some embodiments of the present application. The apparatus 1000 may be a BS 102 or a UE 101 (for example, UE 101a or UE 101b) as shown in FIG. 1.

Referring to FIG. 10, the apparatus 1000 may include at least one non-transitory computer-readable medium 1002, at least one receiving circuitry 1004, at least one transmitting circuitry 1006, and at least one processor 1008. In some embodiments of the present application, at least one receiving circuitry 1004 and at least one transmitting circuitry 1006 and be integrated into at least one transceiver. The at least one non-transitory computer-readable medium 1002 may have computer executable instructions stored therein. The at least one processor 1008 may be coupled to the at least one non-transitory computer-readable medium 1002, the at least one receiving circuitry 1004 and the at least one transmitting circuitry 1006. The computer executable instructions can be programmed to implement a method with the at least one receiving circuitry 1004, the at least one transmitting circuitry 1006 and the at least one processor 1008. The method can be a method according to an embodiment of the present application, for example, the method shown in FIG. 3 or FIG. 5.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for resource alignment on sidelink, including a processor and a memory. Computer programmable instructions for implementing a method for resource alignment on sidelink are stored in the memory, and the processor is configured to perform the computer programmable instructions to implement the method for resource alignment on sidelink. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for resource alignment on sidelink as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. An apparatus, comprising:
a processor; and
a memory coupled with the processor, the processor configured to cause the apparatus to:
receive resource partition information associated with at least one resource partition of a resource pool;
select at least one resource pattern from a set of resource patterns associated with one resource partition of the at least one resource partition according to the received resource partition information; and
transmit an indication to indicate the selected at least one resource pattern.

2. The apparatus of claim 1, wherein the processor is configured to cause the apparatus to determine the one resource partition from the at least one resource partition based on one of:
an indication from a network;
an indication from another apparatus;
zone information; or
pre-configuration.

3. The apparatus of claim 1, wherein the processor is configured to cause the apparatus to receive the resource partition information via at least one of:
a system information block (SIB);
a radio resource control (RRC) signaling;
a medium access control (MAC) control element (CE);
downlink control information (DCI);
sidelink control information (SCI); or
pre-configuration.

4. The apparatus of claim 1, wherein the resource partition information includes the at least one resource partition, and each of the at least one resource partition includes at least one of:
a partition index associated with a corresponding resource partition;
a partition default value indicating whether the corresponding resource partition is default or not;
a maximum number of resource patterns within the corresponding resource partition; or
information for each resource pattern in the corresponding resource partition.

5. The apparatus of claim 4, wherein the information for each resource pattern includes at least one of:
a pattern index associated with a corresponding resource pattern;
a pattern length associated with the corresponding resource pattern;
a pattern periodicity associated with the corresponding resource pattern; or
a maximum number of elements of the corresponding resource pattern.

6. The apparatus of claim 1, wherein, if the apparatus determines to transmit or receive based on a partial sensing using the resource pool with which the resource partition information is associated, then the processor is configured to cause the apparatus to transmit or receive based on the partial sensing using the resource pool with the resource partition information.

7. The apparatus of claim 1, wherein, if the apparatus determines to transmit in a power saving mode using the resource pool with which the resource partition information is associated, then the processor is configured to cause the apparatus to transmit using the resource pool based on the resource partition information.

8. The apparatus of claim 1, wherein the processor is configured to cause the apparatus to:
perform sensing in a sensing duration to identify one or more resource patterns used by at least one second apparatus; and
if no resource pattern used by the at least one second apparatus is identified, select the at least one resource pattern within the at least one resource partition of the resource pool.

9. The apparatus of claim 8, wherein, to select the at least one resource pattern from the set of resource patterns, the processor is configured to cause the apparatus to at least one of:
select at least one default resource pattern from the set of resource patterns as the at least one resource pattern;
randomly select the at least one resource pattern from the set of resource patterns; or
select the at least one resource pattern according to sensing results of the sensing.

10. The apparatus of claim 8, wherein the processor is configured to cause the apparatus to:
select one or more resources within the at least one resource pattern; and
transmit the indication on the selected one or more resources.

11. The apparatus of claim 1, wherein the apparatus is in communication with a second apparatus over sidelink using a first set of resources, and to select is in response to at least one of:
receive a request for resource pattern selection in the first set of resources from the second apparatus;
the apparatus switches from a non-power saving mode to a power saving mode; or
one or more current resource patterns being used by the apparatus cannot satisfy transmission requirements.

12. The apparatus of claim 11, wherein the at least one resource pattern is selected based on at least one of:
transmission requirements between the apparatus and the second apparatus; or
sense results of a sensing performed in a sensing duration, wherein the sensing duration is larger than or equal to a maximum pattern periodicity of the set of resource patterns within the at least one resource partition.

13-15. (canceled)

16. An apparatus, comprising:
a processor; and
a memory coupled with the processor, the processor configured to cause the apparatus to:
receive resource partition information associated with at least one resource partition of a resource pool; and
receive an indication of at least one resource pattern from a set of resource patterns associated with one resource partition of the at least one resource partition.

17. The apparatus of claim 16, wherein the processor is configured to cause the apparatus to transmit a request for resource pattern selection.

18. A method of a first user equipment (UE), comprising:
receiving resource partition information associated with at least one resource partition of a resource pool;
selecting at least one resource pattern from a set of resource patterns associated with one resource partition of the at least one resource partition according to the received resource partition information; and
transmitting an indication to indicate the selected at least one resource pattern.

19. The method of claim 18, further comprising:
determining the one resource partition from the at least one resource partition based on one of:
an indication from a network;
an indication from another UE;
zone information; or
pre-configuration.

20. The method of claim 18, wherein, if the first UE determines to transmit or receive based on a partial sensing using the resource pool with which the resource partition information is associated, then the method further comprises:
transmitting or receiving based on the partial sensing using the resource pool with the resource partition information.

21. The method of claim 18, wherein, if the first UE determines to transmit in a power saving mode using the resource pool with which the resource partition information is associated, then the method further comprises:
transmitting using the resource pool based on the resource partition information.

22. The method of claim 18, further comprising:
performing sensing in a sensing duration to identify one or more resource patterns used by at least one second UE; and
if no resource pattern used by the at least one second UE is identified, selecting the at least one resource pattern within the at least one resource partition of the resource pool.

23. The method of claim 18, wherein the first UE is in communication with a second UE over sidelink using a first set of resources, and the selecting is performed in response to at least one of:
receiving a request for resource pattern selection in the first set of resources from the second UE;
the first UE switching from a non-power saving mode to a power saving mode; or
one or more current resource patterns being used by the first UE cannot satisfy transmission requirements.
